(19) United States
(12) Patent Application Publication
(10) Pub. No.: US 2017/0274325 A1
(43) Pub. Date: Sep. 28, 2017

(54) WATER TREATMENT METHOD

(71) Applicant: TORAY INDUSTRIES, INC., TOKYO (JP)

(72) Inventors: Tomohiro Maeda, Otsu-shi, Shiga (JP); Masahide Taniguchi, Otsu-shi, Shiga (JP); Yohito Ito, Otsu-shi, Shiga (JP)

(73) Assignee: TORAY INDUSTRIES, INC., TOKYO (JP)

(21) Appl. No.: 15/101,176

(22) PCT Filed: Dec. 2, 2014
(86) PCT No.: PCT/JP2014/081910

§ 371 Date: Jun. 2, 2016

(30) Foreign Application Priority Data
Dec. 2, 2013 (JP) 2013-248874

(51) Int. Cl. B01D 65/02; C02F 1/44; B01D 61/58; B01D 69/08; B01D 61/04; B01D 61/02

(52) U.S. Cl. CPC B01D 65/02; B01D 61/04; B01D 61/025; B01D 61/58; B01D 69/08; C02F 1/441; B01D 2311/04; B01D 2321/185; B01D 2321/04; B01D 2321/02; B01D 2321/16; B01D 2317/025; C02F 2209/11; B01D 2315/08; C02F 2103/08

(57) ABSTRACT

The present invention relates to a water treatment method including: a filtration step of feeding water to be treated to a membrane filtration device having loaded therein a porous separation membrane and performing filtration treatment to obtain filtrate; a discharging step of discharging the water to be treated in the membrane filtration device, which has been separated and concentrated by the porous separation membrane; and a cleaning step of cleaning the porous separation membrane by at least one treatment of physical cleaning and chemical cleaning, in which a cycle including a combination of the filtration step, the discharging step and the cleaning step is repeated multiple times, thereby obtaining filtrate. In each cycle, the filtration step and the discharging step are repeated multiple times, and the cleaning step is then carried out.

### TECHNICAL FIELD

The present invention relates to a water treatment method used in a fresh water generation method for obtaining fresh water by pretreating water to be treated with a porous separation membrane and then treating with a reverse osmosis membrane, and relates to a fresh water generation apparatus.

### BACKGROUND ART

In recent years, shortages of water resources are serious, and exploitation of hitherto unutilized water resources has been studied. Attention is being focused on membrane filtration techniques for obtaining fresh water by desalinating seawater or brackish water using a reverse osmosis membrane and for obtaining reused water by cleaning sewage treated water and wastewater treated water or industrial wastewater.

However, in a membrane filtration process using a reverse osmosis membrane, fouling that decreases water permeation performance or removal performance becomes problem on operation. Fouling of a reverse osmosis membrane occurs due to adhesion of fine particles and colloids contained in water to be treated to a membrane surface, adhesion and propagation of microorganisms contained in water to be treated on a membrane surface, or adhesion and deposition of precipitates generated along with the concentration of inorganic substances contained in water to be treated on a membrane surface. Particularly, the occurrence of fouling due to adhesion and propagation of microorganisms in water to be treated, so-called biofouling, becomes a big problem. To suppress the occurrence of this biofouling, it is effective to reduce “microorganisms” and organic substances becoming “nutrient sources (feeds) of microorganisms” by an appropriate pretreatment.

As a method for reducing microorganisms, it is known to continuously or intermittently dose a bactericide such as sodium hypochlorite to feed water for a reverse osmosis membrane and perform sterilization. However, regarding a reverse osmosis membrane of which material is a polyamide type, when the reverse osmosis membrane is brought into contact with a chlorine type bactericide, chemical deterioration of a separation functional layer occurs. Therefore, for example, in Patent Document 1, chemical deterioration of a reverse osmosis membrane is prevented by sterilizing with a free chlorine agent and then dosing a reducing agent such as sodium thiosulfate or sodium hydrogen sulfite before a reverse osmosis membrane, thereby reducing and neutralizing. However, in this method, propagation of sulfur oxidizing bacteria is accelerated, or microorganisms are propagated on the surface of a reverse osmosis membrane by dead microorganisms sterilization-treated as nutrient sources. As a result, the occurrence of biofouling cannot be suppressed, and there was a problem that water permeation performance of a reverse osmosis membrane is deteriorated. Furthermore, a chemical or chemical liquid is used, leading to the increase of running cost.

There are the following documents as patent documents relating to a method for reducing organic substances becoming nutrient sources (feeds) of microorganisms in a pretreatment in order to suppress the occurrence of biofouling of a reverse osmosis membrane.

Patent Document 2 discloses a method of suppressing the occurrence of biofouling in a reverse osmosis membrane by forming a biofilm on the surface of a media filtering material and removing organic substances becoming nutrient sources of microorganisms. However, in this method, the media filtering material cannot surely remove suspended substances (suspended matter) such as silts, microorganisms, organic substances becoming nutrient sources of microorganisms, and the like, and there was a problem that permeation performance of a reverse osmosis membrane is deteriorated.

In a membrane pretreatment of conducting cleaning in high filtration flux every 30 to 60 minutes and removing turbidity and microorganisms using microfiltration or ultrafiltration, soluble organic substances becoming nutrient sources of microorganisms cannot be sufficiently removed. Therefore, Patent Document 3 discloses a method for suppressing the occurrence of biofouling in a reverse osmosis membrane by reducing soluble organic substances by the combination of biological activated carbon and membrane filtration. However, in this method, the removal of soluble organic substances becoming the nutrient sources (feeds) of microorganisms and the removal of microorganisms are carried out in different two processes. Therefore, there were problems that the cost for facilities is high, leading to economical disadvantage, and additionally, operation and maintenance become complicated.

### BACKGROUND ART DOCUMENT

### Patent Document

Patent Document 1: JP-A-59-213495
Patent Document 2: JP-A-2013-111559
Patent Document 3: WO 2006/057249

### SUMMARY OF THE INVENTION

### Problems that the Invention is to Solve

An object of the present invention is to provide a water treatment method for efficiently obtaining fresh water by a reverse osmosis membrane while suppressing the occurrence of biofouling of the reverse osmosis membrane in a fresh water generation method for obtaining fresh water by pretreating water to be treated with a porous separation membrane including any one of a microfiltration membrane, an ultrafiltration membrane and a nanofiltration membrane, and then treating with the reverse osmosis membrane.

### Means for Solving the Problems

In order to solve the above-mentioned problem, the present invention has configurations of the following items (1) to (19).

(1) A water treatment method including:

a filtration step of feeding water to be treated to a membrane filtration device having loaded therein a porous separation membrane and performing filtration treatment of the water to be treated with the porous separation membrane to obtain filtrate;

a discharging step of discharging the water to be treated in the membrane filtration device, which has been separated and concentrated by the porous separation membrane, outside the membrane filtration device; and

a cleaning step of cleaning the porous separation membrane by at least one treatment of physical cleaning and chemical cleaning,

in which a cycle including a combination of the filtration step, the discharging step and the cleaning step is repeated multiple times, thereby obtaining filtrate, and

in each cycle, the filtration step and the discharging step are repeated multiple times, and the cleaning step is then carried out.

(2) The water treatment method according to (1), in which the cleaning step includes at least one of the following steps (a) to (d):

(a) air scrubbing of bringing air bubbles generated from an aeration part arranged in a lower part of the porous separation membrane, into contact with the porous separation membrane;

(b) backpressure washing of stopping the filtration of the water to be treated and passing a liquid from a secondary side of the porous separation membrane to a primary side thereof;

(c) flushing-cleaning of moving a liquid on the primary side of the porous separation membrane in approximately parallel with a surface of the porous separation membrane, thereby cleaning the primary side of the porous separation membrane; and

(d) chemical cleaning of stopping the filtration of the water to be treated and feeding chemical liquid from the primary side or the secondary side of the porous separation membrane.

(3) The water treatment method according to (1) or (2), in which the cleaning step is conducted at an interval of 3 hours or more and 1 month or less from an initiation of the filtration.
(4) The water treatment method according to any one of (1) to (3), in which, in the filtration step, filtration flux or inflow of the water to be treated to the membrane filtration device is adjusted.
(5) The water treatment method according to any one of (1) to (4), in which the filtration flux in the filtration step is 30 L/m²/h or less.
(6) The water treatment method according to any one of (1) to (5), in which, in the filtration step, a filtration pressure difference is 50 kPa or less.
(7) The water treatment method according to any one of (1) to (6), in which, when a turbidity concentration index of the filtrate is measured and a measurement value thereof becomes 2 times or more a measurement value after the initiation of the filtration step, the filtration step is finished to shift to the discharging step.
(8) The water treatment method according to any one of (1) to (7), in which, when an organic concentration index of the filtrate is measured and a measurement value thereof becomes 2 times or more a measurement value after the initiation of the filtration step, the filtration step is finished to shift to the cleaning step.
(9) The water treatment method according to any one of (1) to (8), in which at least one of the filtration flux, the inflow of the water to be treated to the membrane filtration device, and an interval of conducting the discharging step is controlled such that a content of dissolved oxygen contained in the filtrate is lower than a content of dissolved oxygen contained in the water to be treated that is to be fed in the filtration step.
(10) The water treatment method according to any one of (1) to (9), in which the filtration step is dead end filtration.
(11) The water treatment method according to any one of (1) to (10), in which the porous separation membrane is a hollow-fiber membrane, and the water to be treated is brought into contact with an outside of the porous separation membrane and filtrated to an inside of the porous separation membrane.
(12) The water treatment method according to any one of (1) to (11), in which the porous separation membrane is loaded in a cylindrical membrane-loading case, and the cylindrical membrane-loading case is arranged such that a central axis thereof is approximately horizontal.
(13) The water treatment method according to any one of (1) to (12), in which a concentration of microorganisms contained in the water to be treated which has been concentrated and discharged in the discharging step is higher than a concentration of microorganisms contained in the water to be treated that is to be fed in the filtration step.
(14) The water treatment method according to any one of (1) to (13), in which the filtrate has an oxidation-reduction potential of 350 mV or less.
(15) The water treatment method according to any one of (2) to (14), in which cleaning water to be used in the backpressure washing has an oxidation-reduction potential of 500 mV or less.
(16) The water treatment method according to any one of claims 1 to 15, in which the water to be treated is water to be treated which has a soluble organic substance concentration removal ratio of less than 50% and which has been subjected to a filtration treatment having filtration accuracy lower than the porous separation membrane.
(17) The water treatment method according to any one of (1) to (16), in which a biofilm formation rate of the filtrate is ⅕ or less of a biofilm formation rate of the water to be treated.
(18) A fresh water generation method including: subjecting the filtrate obtained by the water treatment method according to any one of (1) to (17) to a desalination treatment.
(19) The fresh water generation method according to (18), in which the desalination treatment is at least one treatment selected from the group consisting of a semipermeable membrane treatment, an ion-exchange treatment, a crystallization treatment and a distillation treatment.

### Advantage of the Invention

According to the present invention, among microorganisms in water to be treated, a suspended matter for adhesion of microorganisms, organic substances becoming nutrient sources (feeds) of microorganisms, and the like, colloidal components having large size are held at the primary side (feed side) of a porous separation membrane by solid-liquid separation function thereof, and among organic substances becoming nutrient sources (feeds) of microorganisms, and the like, soluble components having small size are reduced by pretreatment by clarification function of a biofilm formed on the surface of the porous separation membrane and a biomass including the suspended matter held at the primary side (feed side) of the porous separation membrane, whereby the occurrence of biofouling in a reverse osmosis membrane can be suppressed. Furthermore, by using an outside-in type filtration system in which a porous separation membrane performs filtration from the outside to the inside thereof, and additionally by setting up an interval for carrying out a cleaning step of the porous separation membrane to 3 hours or more and 1 month or less, the above-described two functions can be efficiently developed, and a water generation method for efficiently obtaining fresh water by a reverse osmosis membrane while suppressing the occurrence of biofouling of the reverse osmosis membrane can be provided.

### BRIEF DESCRIPTION OF THE DRAWINGS

FIG. 1 is a schematic view showing one embodiment of a fresh water generation apparatus of the present invention.

FIG. 2 is a schematic view showing other embodiment of a fresh water generation apparatus of the present invention.

FIG. 3 is a schematic view showing other embodiment of a fresh water generation apparatus of the present invention.

FIG. 4 is a schematic view showing other embodiment of a fresh water generation apparatus of the present invention.

### MODE FOR CARRYING OUT THE INVENTION

The present invention is described in further detail below on the basis of the embodiments shown in the drawings. However, the present invention should not be construed as being limited to the following embodiments.

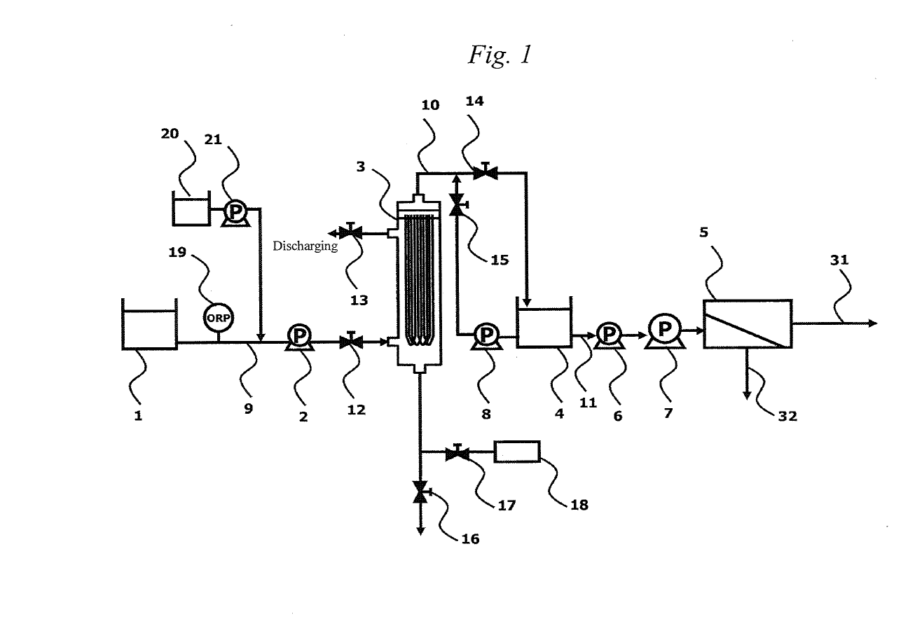

A fresh water generation apparatus according to the present invention, for example as shown in FIG. 1, includes: a water to be treated storage tank 1 that stores water to be treated; a water to be treated feed pump 2 that feeds water to be treated; an outside-in type porous separation membrane module 3 having loaded therein an external pressure filtration type membrane (outside-in type porous separation membrane) that filtrates water to be treated from the outside of the porous separation membrane to the inside thereof; a filtrate storage tank 4 that stores filtrate obtained by filtrating with the outside-in type porous separation membrane; a reverse osmosis membrane unit 5; a booster pump 6 that feeds the filtrate (treated water) to the reverse osmosis membrane unit 5; a booster pump 7 that rises a pressure to separate the filtrate of the outside-in type porous separation membrane module 3 into permeate 31 and concentrate 32 in the reverse osmosis membrane unit 5; and a backwashing pump 8 that feeds the filtrate to perform backpressure washing of the outside-in type porous separation membrane module 3.

The water to be treated storage tank 1 is connected to the outside-in type porous separation membrane module 3 by a water to be treated pipe line 9, the outside-in type porous separation membrane module 3 is connected to the filtrate storage tank 4 by a filtrate pipe line 10, and the filtrate storage tank 4 is connected to the reverse osmosis membrane unit 5 by a reverse osmosis membrane feed water pipe line 11. In order to control the operation of the outside-in type porous filtration membrane module 3, the fresh water generation apparatus further includes: a water to be treated feed valve 12 that opens when feeding the water to be treated; an air vent valve 13 that opens when performing backpressure (backflow) washing or air scrubbing of the outside-in type porous filtration membrane module 3; a filtrate valve 14 that opens when filtrating, a backwashing valve 15 that opens when performing backpressure washing; a discharge valve 16 that opens when discharging water at a primary side (feed side) of the outside-in type porous filtration membrane module 3; and an air valve 17 that opens when feeding compressed air to the lower part of the outside-in type porous filtration membrane module 3 to perform air scrubbing.

In the present fresh water generation apparatus, in the ordinary filtration step, the water to be treated that is stored in the water to be treated storage tank 1 is fed to the primary side (feed side) of the outside-in type porous filtration membrane module 3 by the water to be treated feed pump 2 in the state that the water to be treated feed valve 12 is opened, and pressure filtration of the outside-in type porous filtration membrane module is performed by opening the filtrate valve 14.

The filtrate which has been filtrated by the porous separation membrane is temporality stored in the filtrate storage tank 4, fed to the booster pump 7 by the booster pump 6, pressurized by the booster pump 7, fed to the reverse osmosis membrane unit 5, and separated into the permeate 31 from which a solute such as salt has been removed, and the concentrate 32 in which a solute such as salt has been concentrated.

The present invention suppresses the occurrence of biofouling in a reverse osmosis membrane by reducing microorganisms in the water to be treated and nutrient sources (feeds) of the microorganisms by pretreatment by means of a solid-liquid separation function of a porous separation membrane and a clarification function of a biofilm deposited on the surface of a porous separation membrane and a biomass including a suspended matter held at the primary side (feed side) of the porous separation membrane.

To efficiently develop the above-described clarification function, the present invention provides a water treatment method including: a filtration step of feeding water to be treated to a membrane filtration device (the outside-in type porous separation membrane module 3 in FIG. 1) having loaded therein a porous separation membrane and performing filtration treatment of the water to be treated with the porous separation membrane to obtain filtrate; a discharging step of discharging the water to be treated in the membrane filtration device, which has been separated and concentrated by the porous separation membrane, outside the membrane filtration device; and a cleaning step of cleaning the porous separation membrane by at least one treatment of physical cleaning and chemical cleaning, in which a cycle including a combination of the filtration step, the discharging step and the cleaning step is repeated multiple times, thereby obtaining filtrate, and in each cycle, the filtration step and the discharging step are repeated multiple times, and the cleaning step is then carried out. The discharging step can sufficiently remove a suspended matter and fouling components by discharging a liquid at the primary side of the membrane filtration device. Therefore, the effect of peeling a biofilm deposited on the surface of the porous separation membranes is low, and a run time is short. As a result, it is preferred for the present invention to positively carry out the discharging step.

The cleaning step of the porous separation membrane is a step of cleaning contaminations (fouling) including inorganic substances and organic substances deposited on the surface and inside of the porous separation membrane with continuing the filtration, and is periodically carried out in the case of having reached a predetermined filtration pressure or in the case of having reached a predetermined filtration continuation time.

Examples of a treatment method in the cleaning step include: backpressure (backflow) washing (backwashing) of removing fouling components deposited inside the porous separation membrane by stopping filtration of water to be treated, and passing (that is, backflowing) cleaning water (for example, filtrate of the porous separation membrane) in a direction opposite to a filtration direction of the outside-in type porous separation membrane module 3, that is, toward the primary side (feed side) from the secondary side (filtered side); air (air bubbles) cleaning (so-called air scrubbing) of removing fouling components deposited on the porous separation membrane surface by feeding compressed air from the lower part of the outside-in type porous separation membrane module 3 using an aeration part such as a compressor 18 and bringing air bubbles generated from the aeration part into contact with the porous separation membrane; flushing-cleaning of removing fouling components deposited on the porous separation membrane surface or discharging a suspended matter held at the primary side of the porous separation membrane by flowing water to be treated and the like to the primary side of the filtration membrane at high flux and moving the water and the like in approximately parallel to the porous separation membrane; chemical-reinforcing backpressure washing using cleaning water having added thereto chemical liquid such as sodium hypochlorite when performing backpressure washing; and chemical cleaning of feeding water to be treated for a filtration membrane or filtrate thereof, having added thereto chemical liquid from the primary side or the secondary side of the outside-in type porous separation membrane module, and dipping the porous separation membrane therein. Oxidation-reduction potential of the cleaning water used in backpressure washing is preferably 500 mV or less, more preferably from 0 to 200 mV, and still more preferably from 100 to 200 mV. When the oxidation-reduction potential of the cleaning water is 500 mV or less, oxidation stress of microorganisms can be reduced and additionally, when the oxidation-reduction potential is 0 mV or more, stress of microorganisms due to anaerobic condition can be reduced. Regarding the oxidation-reduction potential of the cleaning water, it is preferred that an oxidation-reduction potentiometer (ORP meter) 19 for measuring oxidation-reduction potential of the cleaning water is installed and oxidation-reduction potential of water to be treated is monitored.

Those cleaning steps may be carried out alone and may be carried out by combining a plurality of the cleaning steps. In the case where the cleaning step is carried out by combining a plurality of the cleaning steps, each step may be carried out simultaneously and may be sequentially carried out. In the present invention, in order to prevent the deterioration of clarification function of a biofilm deposited on the surface of the porous separation membrane and a biomass including a suspended matter held at the primary side of the filtration membrane due to the cleaning step using chemical liquid such as chemical-reinforcing backpressure washing and chemical cleaning, physical cleaning that does not use chemical liquid, such as the above-described backpressure washing, air scrubbing and flushing-cleaning, is preferred. However, for example, in the case where fouling has been excessively deposited, the increase of transmembrane pressure difference of a porous separation membrane can be suppressed by carrying out the cleaning step using chemical liquid. Therefore, it is preferred to decrease the frequency of carrying out the cleaning step using chemical liquid as compared to physical cleaning, and combine with the physical cleaning.

In the present invention, the cleaning step of the porous separation membrane is carried out after repeating the filtration step and the discharging step multiple times in each cycle of the combined cycles of the filtration step, the discharging step and the cleaning step. Deposition of excessive fouling can be prevented by conducting the cleaning step after repeating the filtration step and discharging step multiple times.

Regarding the interval of carrying out the cleaning step of the porous separation membrane, it is preferred that the cleaning step is conducted at an interval of 3 hours or more and 1 month or less from the initiation of the filtration. An interval of 1 day or more and 1 month or less is more preferred. For example, microorganisms floating in seawater tend to rapidly adhere to the filtration membrane or suspended matter in the initial about 3 hours, and thereafter mildly continue the adhesion. Therefore, in order to adhere and form a biofilm to the surface of the porous separation membrane and the suspended matter and efficiently develop clarification function, it is preferred to continue the filtration for 3 hours or more. Furthermore, in order to fix the biofilm to the surface of the porous separation membrane and the suspended matter, it is necessary to consider diurnal variation such as water temperature change of day and night and the rise and fall of the tides, and therefore it is more preferred to continue the filtration for 1 day or more. Furthermore, in order to prevent that: microorganisms excessively propagate on the biofilm formed on the surface of the porous separation membrane and the suspended matter; non-biomass type suspended substances in the water to be treated deposit excessively; metabolites of the biofilm deposit too much; and the suspended matter in the water to be treated adsorb to excessively increase the thickness of the biofilm, thereby making the inside of the biofilm easy to become anaerobic, it is preferred to clean the porous separation membrane once a month.

Although depending on water quality of water to be treated, when retention time in a porous separation membrane is sufficient, clarification function is easy to proceed. Therefore, in order to further stabilize clarification function of a biofilm formed on the surface of the porous separation membrane and a biomass including a suspension form held at the primary side (feed side) of the porous separation membrane, the porous separation membrane is preferably low flux, and specifically it is preferred to set to 0.5 m/d or less.

Furthermore, it is reported that in some microorganisms in water to be treated and nutrient sources (feeds) of microorganisms, when pressure is excessively applied thereto, those are sheared and pass through a filtration membrane. Therefore, in the case where supply pressure of the porous separation membrane exceeds a setting value, it is preferred to carry out the cleaning step of the filtration membrane. Even in the case of carrying out physical cleaning that does not use chemical liquid, suspended matter to which a biofilm present at the primary side (feed side) of the porous separation membrane of the outside-in type porous separation membrane module 3 has been adhered is discharged from the outside-in type porous separation membrane module 3, or the biofilm deposited on the surface of the porous separation membrane is removed by physical cleaning such as air scrubbing or backpressure washing and discharged from the outside-in type porous separation membrane module 3. Therefore, there is a concern that clarification function is temporarily deteriorated. For this reason, it is preferred that the flux of the porous separation membrane is set to be higher than 0.5 m/d for a certain period of time just after the cleaning step of the porous separation membrane, and filtrate of the porous separation membrane is not sent to the filtrate storage tank 4 and is discharged outside the system or is used as cleaning water for backpressure washing of the porous separation membrane. In other words, by increasing the flux of the filtration membrane, microorganisms, organic substances becoming nutrient sources (feeds) of microorganisms, and the like can be promptly fed to the surface of the porous separation membrane in an necessary amount, and additionally, the suspended matter for adhering the biofilm can be replenished to the primary side of the porous separation membrane, whereby the clarification function-deteriorated biomass can be promptly restored. On the other hand, clarification function is further stabilized when the flux of the porous separation membrane is low. Therefore, it is preferred that filtrate when the flux of the porous separation membrane is high is discharged outside the system or is used as cleaning water for backpressure washing of the porous separation membrane.

At least a part of discharged water during the cleaning step that does not use chemical liquid may be recovered and fed to the primary side of the outside-in type porous separation membrane module 3, and may be returned to the water to be treated storage tank 1. This can replenish the suspended matter for adhering the biomass to the primary side of the porous separation membrane and can promptly restore the clarification function-deteriorated biomass.

In many cases, sodium hypochlorite or the like is added when taking water for the purpose of preventing microorganism contamination in pipe lines or apparatus. To protect the biofilm deposited on the surface of the filtration membrane and the biomass including the suspended matter held at the primary side of the filtration membrane, it is preferred that an oxidation-reduction potentiometer (ORP meter) 19 measuring oxidation-reduction potential of water to be treated is installed as shown in FIG. 1 and the oxidation-reduction potential of water to be treated is monitored. In the case where the oxidation-reduction potential of water to be treated is 500 mV or higher, it is preferred that a reducing agent is added from a reducing agent storage tank 20 that stores a reducing agent using a reducing agent dosing pump 21. Alternatively, although not shown in the drawing, a chlorine meter is set up as a substitute of the oxidation-reduction potentiometer (ORP meter) 19, a chlorine concentration of water to be treated is monitored, and, for example, in the case where the chlorine concentration is 0.2 mg/l or more, a reducing agent may be added. When the chlorine concentration is the above-described low concentration range, clarification function of the biofilm deposited on the surface of the porous separation membrane and the biomass including the suspended matter held at the primary side (feed side) of the porous separation membrane is not substantially deteriorated.

The recovery ratio of the porous separation membrane is a ratio of filtrate to feed water of the porous separation membrane. In order to treat water while storing up microorganisms and organic substances becoming nutrient sources (feeds) of microorganisms as much as possible on the surface of the porous separation membrane in a range that pressure of the porous separation membrane does not excessively increase, the recovery ratio of the porous separation membrane is preferably 95% or more, and more preferably 99% or more.

When the filtration flux of the porous separation membrane is low, clarification function is further stabilized. Therefore, it is preferred that the filtration flux of the porous separation membrane or the inflow of water to be treated to a membrane filtration device (outside-in type porous separation membrane module 3) is adjusted in the filtration step. Specifically, it is preferred that operation conditions are set up with long cleaning interval while suppressing the filtration flux of the porous separation membrane.

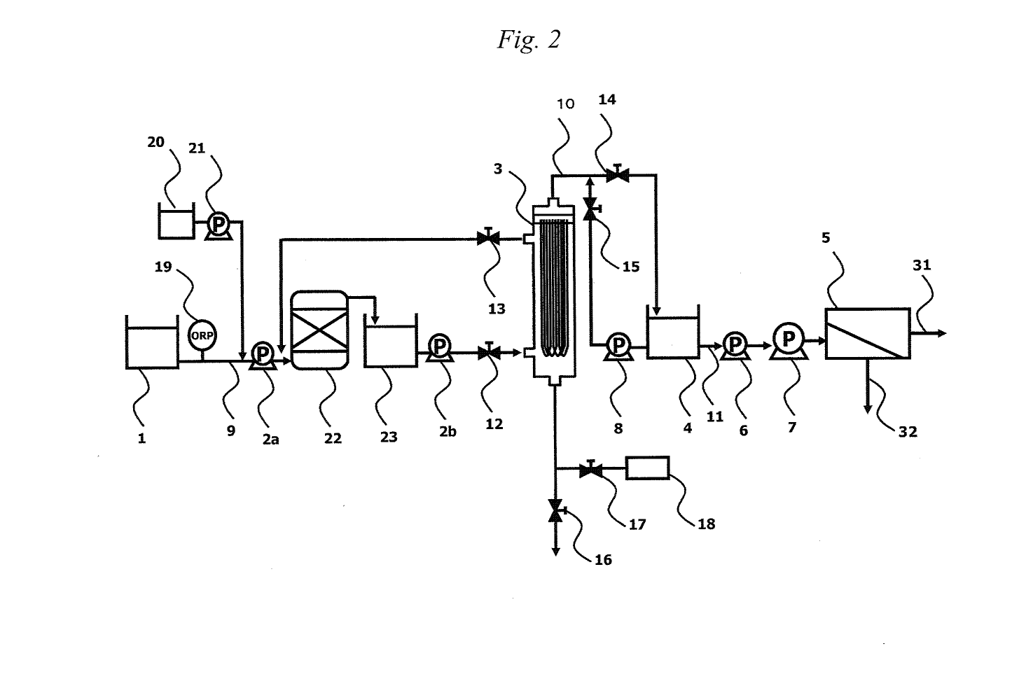

In the present invention, the filtration may be carried out by a dead end filtration system, or may be carried out by a cross-flow filtration system in which the opening of the air vent valve 13 is adjusted as shown in FIG. 2, and discharged water is returned to the upper stream of the porous separation membrane. In the case of the cross-flow filtration system, in order to prevent that the biofilm adhered to the surface of the porous separation membrane is peeled and the suspended matter having clarification function is discharged from the primary side of the porous separation membrane, it is preferred that the system is operated such that the membrane surface flux is as small as possible. From the standpoints of the feeding of the nutrient sources (feeds) to the biofilm deposited on the surface of the porous separation membrane and the biomass including the suspended matter held at the primary side of the porous separation membrane, and suppression of peeling of the biofilm, the filtration flux in the filtration step is preferably 30 L/m²/h or less, and more preferably 15 L/m²/h or less.

In the present invention, it is preferred that filtration pressure difference in the filtration step is 50 kPa or less. The filtration pressure difference is a difference between a filtration pressure at the primary side of the porous separation membrane and a filtration pressure at the secondary side thereof. When the filtration pressure difference is 50 kPa or less, microorganisms on the surface of the porous separation membrane and nutrient sources (feeds) of microorganisms are not subdivided by pressurizing, and can be held on the surface of the porous separation membrane. It is more preferred that the filtration pressure difference is 40 kPa or less.

By combining a pre-filtration treatment unit 22 having filtration accuracy larger than that of the porous separation membrane loaded in the outside-in type porous separation membrane module 3 as shown in FIG. 2, the increase of transmembrane pressure difference of the porous separation membrane can be suppressed, and therefore the clarification function of the present invention can be further stably continued, which is preferred.

The pre-filtration treatment unit 22 develops the clarification function of the present invention by adhering and forming the biofilm to the porous separation membrane and the suspended matter held at the primary side of the porous separation membrane. Therefore, a unit that can remove a certain extent of fouling components such as suspended substances but does not completely block microorganisms and organic substances becoming nutrient sources of microorganisms is preferred. Floating bacteria in water have a shape having a size of from 0.2 to 0.3 μm at the shortest and from 10 μm or more at the longest. Therefore, for example, a filter having filtration accuracy of 10 μm or less and a media filter having an average particle size of 0.5 mm or less are preferred as the pre-filtration treatment unit 22, and those may be used alone or by combining those.

As the media filter having an average particle size of 0.5 mm or less, a gravity filtration of a natural flow down system can be applied, and a pressure type filtration in which a pressure tank is packed with sand can be also applied. Sand containing a single component can be applied as media to be packed in the pre-filtration treatment unit 22. However, for example, it is possible to enhance filtration efficiency by combining anthracite, silica sand, garnet, pumice stone, activated carbon and the like. Above all, it is preferred to use porous media in which a biofilm is easy to be formed on the surface thereof. Examples of the filter having filtration accuracy of 10 μm or less include a string wound filter, a nonwoven filter, a microfiltration membrane, an ultrafiltration membrane and a nanofiltration membrane capable of separating dissolved substances.

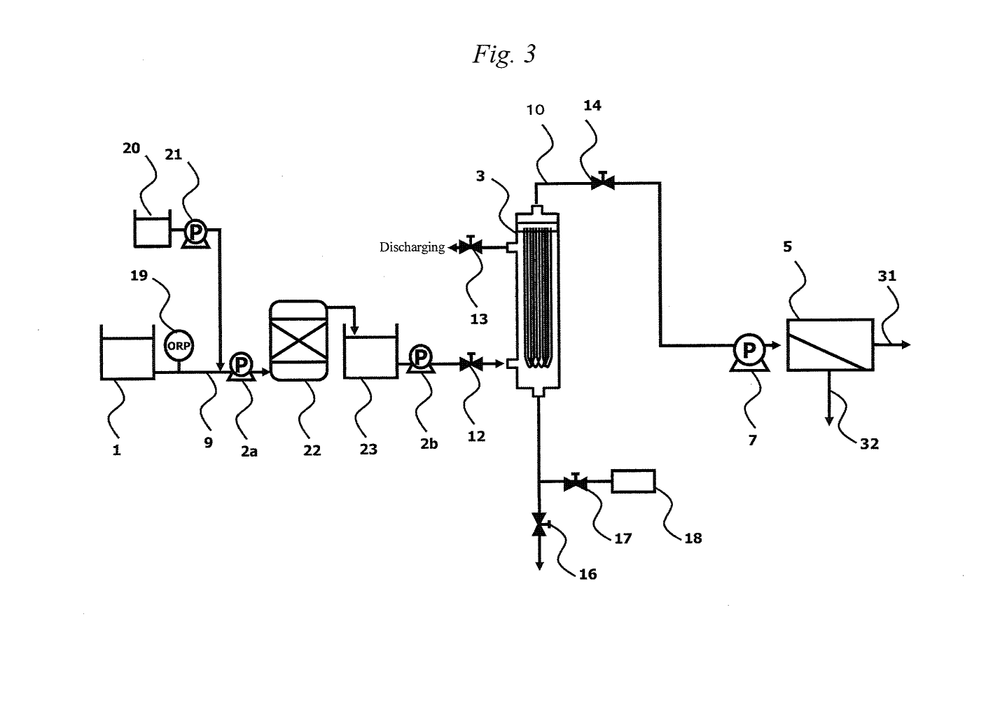

As shown in FIG. 3, by omitting the filtrate storage tank 4 (intermediate tank) that stores filtrate which has been filtrated with a porous separation membrane and directly feeding the filtrate of the outside-in type porous separation membrane module 3 to the reverse osmosis membrane unit 5, RO biofouling in post-stage due to growth of microorganisms in the intermediate tank can be suppressed, and additionally, the filtrate storage tank 4 (intermediate tank) and the booster pump 6 can be omitted. Therefore, this leads to the reduction in the cost of facilities and space saving, which is preferred. In the case of omitting the filtrate storage tank (intermediate tank) 4 and the booster pump 6, the filtrate of the porous separation membrane is made to have a pressure of from 0.05 to 0.2 MPa such that cavitation is not generated in the booster pump 7, and the filtrate is fed to the booster pump 7. As a result, the filtrate is separated into permeate and concentrate in the reverse osmosis membrane unit 5. Therefore, in the case of omitting the filtrate storage tank 4 and the booster pump 6, a plurality of porous separation membranes are arranged in parallel, and in the case where a part of the porous separation membranes is being cleaned, necessary quantity of water and pressure for the reverse osmosis membrane unit 5 are replenished by other porous separation membranes. Thus, it is preferred to establish continuously operable state as the whole fresh water production apparatus.

Furthermore, when the pre-filtration-treated water storage tank 23 that stores the filtrate of the pre-filtration treatment unit 22 is omitted, thereby omitting a water to be treated feed pump 2b that feeds the water to be treated, and filtration of the outside-in type porous separation membrane module 3 and filtration of the pre-filtration treatment unit 22 are carried out by only a water to be treated feed pump 2a, this further leads to the reduction of the cost of facilities and space saving, which is preferred. Furthermore, although not shown in the drawings, a safety filter that is frequently arranged just before the reverse osmosis membrane 5 can be omitted, and this leads to reduction of the cost of facilities, which is preferred.

Even though biofouling of the reverse osmosis membrane could be suppressed by applying the present invention, in the case where the fouling of the reverse osmosis membrane occurs due to: adhesion of fine particles and colloids in water to be treated to the surface of the reverse osmosis membrane; adhesion and deposition of precipitates generated by the concentration of inorganic substances contained in water to be treated to the surface of the reverse osmosis membrane; and adhesion and propagation of microorganisms in the water to be treated occurred at least on the surface of the reverse osmosis membrane, a method of restoring by cleaning with chemical liquid is applied. However, chemical cleaning is generally required to stop the operation. Therefore, it is preferred that the chemical cleaning should be carried out as little as possible from the standpoints of cost of chemical liquid, deterioration of a reverse osmosis membrane by chemical liquid, and the like. For this reason, a method called physical cleaning such as flushing-cleaning that flows water to be treated or permeate to the feed side of a reverse osmosis membrane in high flux, or backpressure washing that applies backpressure from the filtered side of a reverse osmosis membrane to flow backward permeate to the feed side of the reverse osmosis membrane, thereby floating adhered fouling matters, and removing those, is applied before reaching chemical cleaning in many cases.

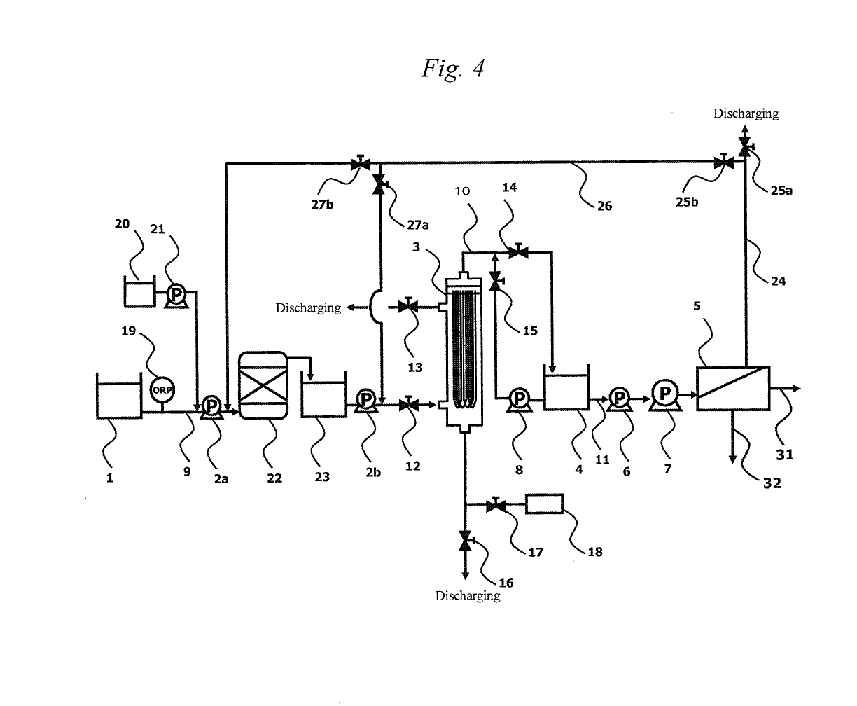

As shown in FIG. 4, discharging water which has been used for those physical cleanings is generally discharged outside the system. However, many biofilms which had been adhered to the surface of the reverse osmosis membrane float in the discharging water which has been used for physical cleanings. Therefore, by feeding the water to be treated to the outside-in type porous separation membrane module 3 and/or the pre-filtration treatment unit 22 and performing filtration, microorganisms that are likely to be adhered to the reverse osmosis membrane can be replenished to the inside of the outside-in type porous separation membrane module 3 and/or the pre-filtration treatment unit 22, and this leads to the increase of clarification function, which is preferred. Furthermore, the function is temporality decreased just after the cleaning step of the outside-in type porous separation membrane module 3 and the pre-filtration treatment unit 22. Therefore, it is more preferred to feed discharging water which has been used for physical cleanings of the reverse osmosis membrane just after the cleaning step to the outside-in type porous separation membrane module 3 and/or the pre-filtration treatment unit 22. Discharging water which has been used for physical cleanings such as flushing-cleaning and backpressure washing of the reverse osmosis membrane passes through a reverse osmosis membrane concentrate line 24, is fed to a reverse osmosis membrane physical cleaning feed water line 26 by closing a reverse osmosis membrane concentrate switching valve 25a and opening a reverse osmosis membrane concentrate switching valve 25b. In the case of feeding to the outside-in type porous separation membrane module 3, a reverse osmosis membrane physical cleaning water feed valve 27a is opened, and in the case of feeding to the pre-filtration treatment unit 22, a reverse osmosis membrane physical cleaning water feed valve 27b is opened.

Regarding the interval of carrying out the cleaning step of the porous separation membrane of the present invention, the quality of water to be treated, water to be treated which has been concentrated at the primary side of the porous separation membrane and/or filtrate is monitored, and in the case where a measurement value thereof deviates a set-up value, it is preferred to carry out the cleaning step since filtrate having good quality can be stably fed by the reverse osmosis membrane 5.

Examples of the monitoring items of the quality of water include total organic carbon (TOC) concentration, assimilatory organic carbon (AOC), dissolved organic carbon (DOC) concentration, chemical oxygen demand (COD), biological oxygen demand (BOD), ultraviolet absorption (UV), transparent exopolymer particle (TEP), adenosine triphosphate (ATP), biofilm formation rate (BFR), dissolved oxygen (DO), turbidity concentration and organic concentration.

Of those, the biofilm formation rate (BFR) is preferred for monitoring ease of the biofouling formation on the surface of a reverse osmosis membrane. In the case where feed pressure of a reverse osmosis membrane becomes high, the transparent exopolymer particle (TEP) is preferred for monitoring subdivided microorganisms leaked to the secondary side (filtered side) of a reverse osmosis membrane, and the dissolved oxygen (DO) is preferred for monitoring such that the primary side of a filtration membrane does not become excessive anaerobic state.

Regarding the dissolved oxygen (DO), it is preferred to control at least one of filtration flux, inflow of water to be treated to a membrane filtration device and an interval of conducting the discharging step such that the content of dissolved oxygen contained in the filtrate is lower than the content of dissolved oxygen contained in the water to be treated that is to be fed in the filtration step. It is more preferred to control such that the content of dissolved oxygen contained in the filtrate is at least 1 mg/L lower than the content of dissolved oxygen contained in the water to be treated that is to be fed in the filtration step, and it is still more preferred to control such that the content of dissolved oxygen contained in the filtrate is at least 2 mg/L lower than the content of dissolved oxygen contained in the water to be treated that to be is fed in the filtration step.

Regarding the turbidity concentration, it is preferred to control such that when a measurement value of a turbidity concentration index of suspended matters contained in filtrate becomes 2 times or more a measurement value after the initiation of the filtration step, the filtration step is finished to shift to the discharging step. The turbidity concentration of the filtrate can be measured by: a transmitted light turbidity in which intensity of transmitted light passed through filtrate is measured and the turbidity is obtained by a calibration curve prepared using a standard solution; a scattered light turbidity in which intensity of light scattered by particles in filtrate is measured and the turbidity is obtained by a calibration curve prepared using a standard solution; an integrating sphere turbidity in which a ratio between intensity of scattered light by particles in filtrate and intensity of transmitted light is obtained and the turbidity is obtained by a calibration curve prepared using a standard solution; or the like. It is preferred to use as a sensor a turbidity meter (JIS K0101) generally used in water quality control.

Regarding the organic concentration, it is preferred to control such that when a measurement value of an organic concentration index of organic substances contained in filtrate is 2 times or more a measurement value after the initiation of the filtration step, the filtration step is finished to shift to the cleaning step. The organic concentration of the filtrate can be measured by total organic carbon (TOC) concentration, assimilatory organic carbon (AOC), dissolved organic carbon (DOC) concentration, chemical oxygen demand (COD), biological oxygen demand (BOD), ultraviolet absorption (UV), and transparent exopolymer particle (TEP) in the filtrate. Specifically, TOC and DOC can be measured by a combustion catalytic oxidation method that measures carbon dioxide generated by completely combusting filtrate, or a wet oxidation method that adds an oxidizing agent to filtrate, detects generated carbon dioxide by an infrared gas analysis part, and measures the same. COD can be obtained by measuring a content of oxygen consumed by oxidizing organic substances in filtrate with a strong oxidizing agent, and BOD can be obtained by measuring a content of oxygen decomposed by microorganisms by allowing filtrate to stand at 20° C. for 5 days. Furthermore, the ultraviolet absorption (UV) can be obtained by measuring components having an aromatic ring and an unsaturated double bond in filtrate from the absorbed amount by irradiating the filtrate with 254 nm ultraviolet rays, and TEP can be obtained by dyeing polysaccharides in filtrate with Alcian Blue or the like and visualizing, thereby quantifying.

Regarding monitoring of these items of the quality of water, each cleaning step may be performed alone, or a plurality of cleaning steps may be combined and performed. Among the above-described water quality measurement methods of filtrate, a method that can perform on-line measurement such that the monitoring result can be fed back to the filtration step and the cleaning step in accurate timing is preferred.

The chemical liquid to be used in the cleaning step such as chemical-reinforcing backwashing or chemical dipping cleaning may be any of an acid, an alkali, an oxidizing agent, a reducing agent, a chelate agent, a surfactant and the like. Of those, a material that can be neutralized after use, for example, an acid, an alkali, an oxidizing agent or a reducing agent, is preferred. In the case of chemical liquid that cannot be neutralized, a large amount of diluting water for diluting (for example, filtrate of a filtration membrane) is required or treatment cost of chemical wastewater is increased, and this is not preferred.

The outside-in type porous separation membrane module 3 in the present invention may be a submerged type in which a filtration membrane is submerged in a submerging tank containing water to be treated and the water to be treated is suction-filtrated with a pump, a siphon or the like, other than a pressurized type as shown in FIG. 1. In the case of the pressurized type, it is difficult in an internal pressurized type to hold suspended substances for adhering biofilms, at the primary side (feed side) of the porous separation membrane. Therefore, an outside-in type porous separation membrane is preferred.

Furthermore, it is preferred that the porous separation membrane is loaded in a cylindrical membrane-loading case, and the cylindrical membrane-loading case is arranged such that a central axis thereof is approximately horizontal.

The porous separation membrane includes any of a microfiltration membrane, an ultrafiltration membrane and a nanofiltration membrane. As the shape of the outside-in type porous separation membrane, a shape having a large membrane surface area necessary for adhesion of biofilms is preferred, a hollow-fiber membrane or a tubular membrane is more preferred, and a hollow-fiber membrane in which shear stress by cross-flow is relatively difficult to generate so that biofilms adhered to the membrane surface do not peel is still more preferred.

It is preferred that the material of the porous separation membrane contains at least one kind selected from the group consisting of an inorganic material such as ceramic, polyethylene, polypropylene, polyacrylonitrile, ethylene-tetrafluoroethylene copolymer, polychlorotrifluoroethylene, polytetrafluoroethylene, polyvinyl fluoride, tetrafluoroethylene-hexafluoropropylene copolymer, tetrafluoroethylene-perfluoroalkyl vinyl ether copolymer, chlorotrifluoroethylene-ethylene copolymer, polyvinylidene fluoride, polysulfone, cellulose acetate, polyvinyl alcohol, polyether sulfone and polyvinyl chloride. Furthermore, the material of the porous separation membrane is more preferably polyvinylidene fluoride (PVDF) from the standpoints of membrane strength and chemical resistance, and polyacrylonitrile is more preferred from the standpoints of high hydrophilicity and high contamination resistance.

Pore size of the hollow-fiber membrane surface is not particularly limited, and the membrane may be MF membrane or UF membrane. The pore size thereof can be appropriately selected from a range of from 0.01 μm to 10 μm.

Filtration flow rate controlling method of the outside-in type porous separation membrane module 3 and the pre-filtration treatment unit 22 may be constant flow filtration or constant pressure filtration. However, constant flow filtration is preferred from the standpoint of ease of control of the produced filtrate amount.

The filtrate separated by the porous separation membrane of the outside-in type porous separation membrane module 3 that is a membrane filtration device is stored in the filtrate storage tank 4 and transferred to the reverse osmosis membrane unit 5, whereby the permeate 31 and the concentrate 32 are obtained, as shown in FIG. 1. The water to be treated which has been concentrated and is remained at the primary side in the outside-in type porous separation membrane module 3 is discharged outside the outside-in type porous separation membrane module 3 by the discharging step. The discharging step can be carried out by opening the discharge valve 16 or the air vent valve 13.

It is preferred in the present invention that the concentration of microorganisms contained in the water to be treated which has been concentrated and discharged in the discharging step is higher than the concentration of microorganisms contained in the water to be treated that is to be fed in the filtration step. When the concentration of microorganisms contained in the water to be treated which has been concentrated is higher than the concentration of microorganisms contained in the water to be treated that is to be fed in the filtration step, the precision of suppressing the biofouling occurrence becomes further high. The concentration of microorganism in the water to be treated can be controlled based on the concentration of microorganisms in a part of the water to be treated which has been concentrated and extracted by opening the discharge valve 16 or the air vent valve 13.

In the present invention, the oxidation-reduction potential of the filtrate is preferably 350 mV or less, and more preferably from 200 to 100 mV. When the oxidation-reduction potential of the filtrate is 350 mV or less, the filtration can be continued without applying stress to microorganisms deposited on the surface of the porous separation membrane. The oxidation-reduction potential of the filtrate can be controlled by installing the oxidation-reduction potentiometer (ORP meter) 19 that measures oxidation-reduction potential of the water to be treated, monitoring the oxidation-reduction potential of the water to be treated, and adding a reducing agent based on the oxidation-reduction potential of the water to be treated.

Furthermore, it is preferred in the present invention that a biofilm formation rate of the filtrate is ⅕ or less of a biofilm formation rate of the water to be treated. The biofilm formation rate is an index of an increase rate of the amount of biofilms, and when the biofilm formation rate of the filtrate is within the above-described range, the occurrence of biofouling can be suppressed, which is preferred. It is more preferred that the biofilm formation rate of the filtrate is 1/10 or less the biofilm formation rate of the water to be treated. Furthermore, when the biofilm formation rate of the filtrate is 20 pg/cm²/d or less, biofouling is difficult to be generated, and the biofilm formation rate of 10 pg/cm²/d or less is more preferred.

The filtrate obtained by the water treatment method of the present invention is subjected to desalination treatment by the reverse osmosis membrane unit 5, thereby producing desired fresh water as the filtrate 31. It is preferred that the desalination treatment is at least one treatment selected from the group consisting of semipermeable membrane treatment, ion-exchange treatment, crystallization treatment and distillation treatment.

The reverse osmosis membrane is a membrane having semi-permeability in which a part of components in water to be treated, such as a solvent is permeated, and other components are not permeated, and includes a reverse osmosis membrane (RO membrane). A polymer material such as a cellulose acetate polymer, polyamide, polyester, polyimide or a vinyl polymer is generally used as a material of the reverse osmosis membrane. Membrane structure of the reverse osmosis membrane is that a dense layer is present on at least one surface of the membrane, and an asymmetric membrane which has micro-pores having a pore size gradually increasing from the dense layer toward the inside of the membrane or the other surface, a composite membrane having an extremely thin separation functional layer formed on the dense layer of the asymmetric membrane and made of another material, and the like can be appropriately used. There are a hollow-fiber membrane and a flat-sheet membrane as the form of a membrane. Examples of the representative membrane include cellulose acetate type or polyamide type asymmetric membrane and polyamide type or polyurea type composite membrane having a separation functional layer, though the present invention can be carried out regardless of membrane material, membrane structure and membrane form and the effect of the present invention can be obtained in any of these cases. Cellulose acetate type asymmetric membrane and polyamide type composite membrane are preferably used from the standpoints of the fresh water generation rate, durability and salt removal ratio.

Feed pressure of the reverse osmosis membrane unit 5 is from 0.1 MPa to 15 MPa, and is appropriately differently used depending on the kind of water to be treated, operation method, and the like. In the case where water having low osmotic pressure, such as brackish water or ultrapure water, is used as feed water, it is used at relatively low pressure, and in the case of seawater desalination, wastewater treatment, recovery of valuables, and the like, it is used at relatively high pressure.

In the present invention, the reverse osmosis membrane unit 5 is not particularly limited, but for facilitating handling, a unit produced by putting hollow-fiber membrane type or flat-sheet membrane type semipermeable membrane in a case to prepare a fluid separation element and mounting the element in a pressure vessel is preferably used. In the case of forming with a flat-sheet membrane type semipermeable membrane, the fluid separation element is generally one in which a semipermeable membrane is spirally wound around a cylindrical center pipe having many holes perforated thereon, together with a channel material (net), and examples of the commercially available product thereof include reverse osmosis membrane elements TM700 Series and TM800 Series, manufactured by Toray Industries, Inc. Furthermore, one fluid separation element may constitute the semipermeable membrane unit, or a plurality of fluid separation elements may be connected in series or in parallel to constitute a semipermeable membrane unit.

It is preferred in the present invention that the water to be treated used to obtain fresh water is water to be treated which has a soluble organic substance concentration removal ratio of less than 50% and which has been subjected to a filtration treatment having filtration accuracy lower than the porous separation membrane. Microorganisms and nutrient sources (feeds) of microorganisms can be fed to the surface of the porous separation membrane by conducting a filtration treatment having filtration accuracy lower than the porous separation membrane before the treatment with a membrane filtration device to achieve a soluble organic substance concentration removal ratio of less than 50%. Examples of this filtration treatment method include sand filtration, string wound filter, non-woven fabric filter filtration, and membrane filtration.

Although the present invention has been described in detail and by reference to the specific embodiments, it is apparent to one skilled in the art that various modifications or changes can be made without departing the spirit and scope of the present invention. This application is based on Japanese Patent Application No. 2013-248874 filed on Dec. 2, 2013, the contents of which are incorporated herein by reference.

### INDUSTRIAL APPLICABILITY

The present invention can provide a water treatment method and a fresh water generation apparatus for efficiently obtaining fresh water by a reverse osmosis membrane while suppressing the occurrence of biofouling of the reverse osmosis membrane in a fresh water generation method for obtaining fresh water by pretreating water to be treated with a porous separation membrane including any one of a microfiltration membrane, an ultrafiltration membrane and a nanofiltration membrane, and then treating with a reverse osmosis membrane.

### DESCRIPTION OF REFERENCE NUMERALS AND SIGNS

1: Water to be treated storage tank
2: Water to be treated feed pump
3: Outside-in type porous separation membrane module
4: Filtrate storage tank
5: Reverse osmosis membrane unit
6: Booster pump
7: Booster pump
8: Backwashing pump
9: Water to be treated pipe line
10: Filtrate pipe line
11: Reverse osmosis membrane feed water pipe line
12: Water to be treated feed valve
13: Air vent valve
14: Filtrate valve
15: Backwashing valve
16: Discharge valve
17: Air valve
18: Compressor
19: Oxidation-reduction potentiometer (ORP meter)
20: Reducing agent storage tank
21: Reducing agent dosing pump
22: Pre-filtration treatment unit
23: Pre-filtration-treated water storage tank
24: Reverse osmosis membrane concentrate line
25a, 25b: Reverse osmosis membrane concentrate switching valve
26: Reverse osmosis membrane physical cleaning feed water line
27a, 27b: Reverse osmosis membrane physical cleaning water feed valve
31: Permeate
32: Concentrate

1. A water treatment method comprising:
a filtration step of feeding water to be treated to a membrane filtration device having loaded therein a porous separation membrane and performing filtration treatment of the water to be treated with the porous separation membrane to obtain filtrate;
a discharging step of discharging the water to be treated in the membrane filtration device, which has been separated and concentrated by the porous separation membrane, outside the membrane filtration device; and
a cleaning step of cleaning the porous separation membrane by at least one treatment of physical cleaning and chemical cleaning,
wherein a cycle comprising a combination of the filtration step, the discharging step and the cleaning step is repeated multiple times, thereby obtaining filtrate, and
in each cycle, the filtration step and the discharging step are repeated multiple times, and the cleaning step is then carried out.

2. The water treatment method according to claim 1, wherein the cleaning step comprises at least one of the following steps (a) to (d):
(a) air scrubbing of bringing air bubbles generated from an aeration part arranged in a lower part of the porous separation membrane, into contact with the porous separation membrane;
(b) backpressure washing of stopping the filtration of the water to be treated and passing a liquid from a secondary side of the porous separation membrane to a primary side thereof;
(c) flushing-cleaning of moving a liquid on the primary side of the porous separation membrane in approximately parallel with a surface of the porous separation membrane, thereby cleaning the primary side of the porous separation membrane; and
(d) chemical cleaning of stopping the filtration of the water to be treated and feeding chemical liquid from the primary side or the secondary side of the porous separation membrane.

3. The water treatment method according to claim 1, wherein the cleaning step is conducted at an interval of 3 hours or more and 1 month or less from an initiation of the filtration.

4. The water treatment method according to claim 1, wherein, in the filtration step, filtration flux or inflow of the water to be treated to the membrane filtration device is adjusted.

5. The water treatment method according to claim 1, wherein the filtration flux in the filtration step is 30 L/m²/h or less.

6. The water treatment method according to claim 1, wherein, in the filtration step, a filtration pressure difference is 50 kPa or less.

7. The water treatment method according to claim 1, wherein, when a turbidity concentration index of the filtrate is measured and a measurement value thereof becomes 2 times or more a measurement value after the initiation of the filtration step, the filtration step is finished to shift to the discharging step.

8. The water treatment method according to claim 1, wherein, when an organic concentration index of the filtrate is measured and a measurement value thereof becomes 2 times or more a measurement value after the initiation of the filtration step, the filtration step is finished to shift to the cleaning step.

9. The water treatment method according to claim 1, wherein at least one of the filtration flux, the inflow of the water to be treated to the membrane filtration device, and an interval of conducting the discharging step is controlled such that a content of dissolved oxygen contained in the filtrate is lower than a content of dissolved oxygen contained in the water to be treated that is to be fed in the filtration step.

10. The water treatment method according to claim 1, wherein the filtration step is dead end filtration.

11. The water treatment method according to claim 1, wherein the porous separation membrane is a hollow-fiber membrane, and the water to be treated is brought into contact with an outside of the porous separation membrane and filtrated to an inside of the porous separation membrane.

12. The water treatment method according to claim 1, wherein the porous separation membrane is loaded in a cylindrical membrane-loading case, and the cylindrical membrane-loading case is arranged such that a central axis thereof is approximately horizontal.

13. The water treatment method according to claim 1, wherein a concentration of microorganisms contained in the water to be treated which has been concentrated and discharged in the discharging step is higher than a concentration of microorganisms contained in the water to be treated that is to be fed in the filtration step.

14. The water treatment method according to claim 1, wherein the filtrate has an oxidation-reduction potential of 350 mV or less.

15. The water treatment method according to claim 2, wherein cleaning water to be used in the backpressure washing has an oxidation-reduction potential of 500 mV or less.

16. The water treatment method according to claim 1, wherein the water to be treated is water to be treated which has a soluble organic substance concentration removal ratio of less than 50% and which has been subjected to a filtration treatment having filtration accuracy lower than the porous separation membrane.

17. The water treatment method according to claim 1, wherein a biofilm formation rate of the filtrate is ⅕ or less of a biofilm formation rate of the water to be treated.

18. A fresh water generation method comprising: subjecting the filtrate obtained by the water treatment method according to claim 1 to a desalination treatment.

19. The fresh water generation method according to claim 18, wherein the desalination treatment is at least one treatment selected from the group consisting of a semipermeable membrane treatment, an ion-exchange treatment, a crystallization treatment and a distillation treatment.
